(19) United States
(12) Patent Application Publication
(10) Pub. No.: US 2008/0235730 A1
(43) Pub. Date: Sep. 25, 2008

(54) Perspective Function For Simple Program Guide

(75) Inventor: Fabien M.J. Guillorit, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC , N.V., Eindhoven (NL)

(21) Appl. No.: 10/597,423

(22) PCT Filed: Jan. 25, 2005
(86) PCT No.: PCT/IB2005/050301

§ 371 Date: Jul. 25, 2006

Related U.S. Application Data
(60) Provisional application No. 60/539,789, filed on Jan. 27, 2004.

(51) Int. Cl. H04N 5/445

(52) U.S. Cl. 725/44

(57) ABSTRACT

An electronic program guide (100) includes a first list (105) with first information and a second list (110) which is displayed concurrently with the first list (105) in response to selection of a selected information (115) from the first information, which includes a channel list, a theme list, a time list, a favorite list or a reminder list, switchable in response to activation of a programmable perspective switch (155, 250). The first list (105) is displayed in response to accessing the electronic program guide (100), such as by activating an access switch (240) of a remote controller (200). Both the first and second lists are displayed in response to accessing the second list, such as by double clicking on the access switch (240) or activating a program switch (245) of the remote controller (200). The second list includes information associated with the selected information from the first list.

The present invention relates generally to on-screen display (OSD) methods for an electronic program guide (EPG), menu system, and remote controller for television or the like.

Television broadcasting includes an EPG, which is displayed on televisions as an OSD. Remote controllers are typically used to navigate the EPG. An example of an on-screen display of an EPG and remote controllers is disclosed in U.S. Patent Application Publication No. US 2002/0083449 A1, entitled “Composition Method of On-Screen Display, Menu and Remote Controller for Digital Television” the entire contents of which is incorporated herein by its reference.

Conventional OSDs of EPGs display much information all at once, such as lists including various services or channels as well as the programs on all the listed channels for a time frame of several hours or days. Displayed information includes time of day, day of week, titles, genres like action, comedy-action, suspense-action, comedy, comedy-drama, drama, news, show ratings (sex, violence, etc.), language description, and sports, such as baseball, football, hockey, soccer, and basketball. Conventional displays of EPGs have multiple fields, where some fields such as show-description fields have upwards of 100 characters. Displaying such a large amount of information is not only overwhelming and thus confuses the user, but also decreases the speed of refreshing the display of menus and information as the user navigates through the EPG. Accordingly there is a need for a faster and more versatile EPG control and display system where only relevant information, which is chosen or programmable by the user, is displayed quickly resulting in a user-friendly and fast EPG system.

According to one embodiment of the invention, an EPG and/or controller is provided for quick navigation and display of relevant information in a user-friendly manner. The EPG includes a first list with first information and a second list which is displayed concurrently with the first list in response to selection of a selected information from the first information, which includes a channel list, a theme list, a time list, a favorite list, a reminder list or any other list programmable by the user for example, switchable in response to activation of a programmable perspective switch. The first list is displayed in response to accessing the electronic program guide, such as by activating an access switch of a remote controller. Both the first and second lists are displayed in response to accessing the second list, such as by double clicking on the access switch or activating a program switch of the remote controller. The second list includes information associated with the selected information from the first list.

These and other features, aspects, and advantages of the apparatus and methods of the present invention will become better understood with regard to the following description, appended claims, and accompanying drawings where:

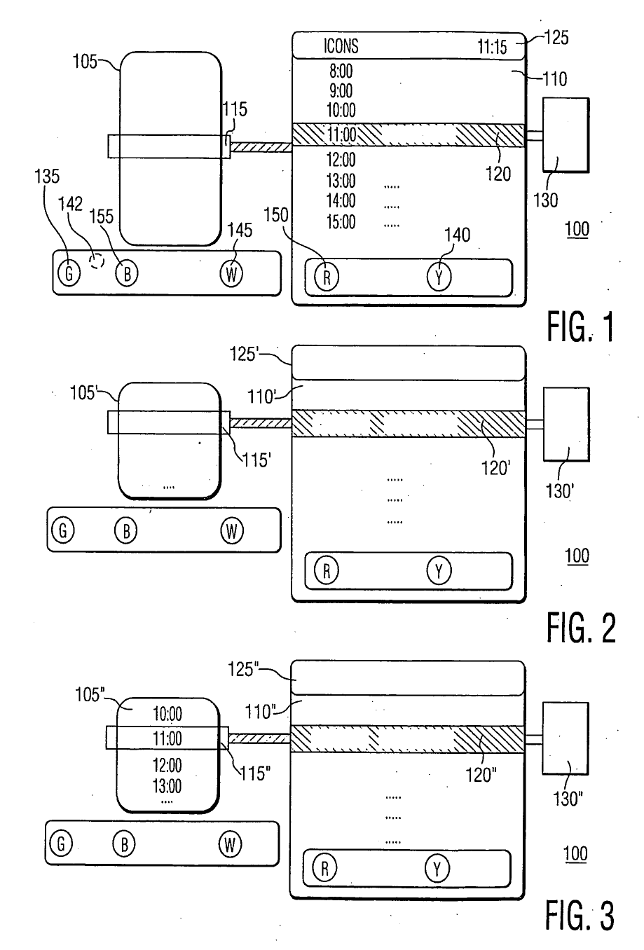

FIGS. 1-3 show implementations of an electronic program guide (EPG) according to the present invention;

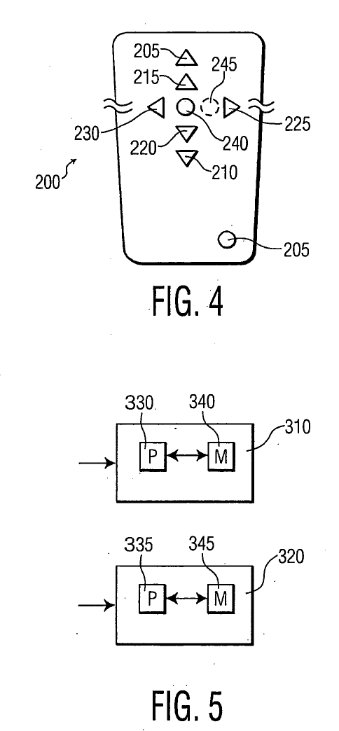

FIG. 4 shows a remote controller for controlling the EPG shown in FIGS. 1-3 according to the present invention; and

FIG. 5 shows receivers that receive the EPG shown in FIGS. 1-3 according to the present invention.

Although this invention is applicable to numerous and various types of content for which an EPG is provided, it has been found particularly useful in the environment of video content and more particularly in the environment of television programming. Therefore, without limiting the applicability of the invention to EPGs for video content and television programming, the invention will be described in such an environment.

Referring now to FIG. 1, there is shown an implementation of an electronic program guide 100 according to the invention comprising a first list 105, which in this case is a channel list of available services or channels, where channels A through I are displayed on one page of the first list 105, for example. The EPG 100 also includes a second list 110, which, in the case where the first list 105 includes a list of channels, is a list of programs associated with the selected channel 115 from the first list 105, and times associated with the programs. The programs on the second list 110 are exclusively associated with the selected channel 115, e.g., channel E, and are displayed in a chronological order such as programs beginning with 8:00 o'clock to 15:00 hours when the current time is around 11:00, for example. Programs associated with channels other than the selected channel are not displayed, thus reducing clutter and user confusion, as well as increasing the speed of display and refreshing or changing thereof. Selected items are differentiated from the rest, such as being surrounded by a box, highlighted or the like. As will be described, menu or list items are selected by moving a cursor which moves the box or the highlight.

The program associated with the current time is highlighted. For example, when the current time is 11:15, then the program on channel E that has started at 11:00 (or earlier if started earlier) is highlighted as indicated by reference numeral 120. The default time line begins and ends a certain interval or intervals from the current time, which intervals are programmable and may be changed as desired. For example, the timeline beginning with 8:00 o'clock and ending with 15:00 hours is displayed on a page of the second list 110 when the current time is 11:15, in this example, the intervals being −3 hours from the nearest current hour of 11:00 resulting in a starting time of 8:00, and an interval of +4 from 11:00 resulting in an end time of 15:00. The intervals before and after the current time are selectable so that the second list 110 may begin and end with selectable times.

The first list 105 is the default list and is displayed when a user first accesses the EPG or asks for the first list 105, while the second list 110 is hidden and not displayed. If the user accesses or selects the second list 110, then both the first and second lists 105, 110 will be displayed. Displaying both lists provides easier navigation since the second list 110 alone does not provide means for selecting another channel for example; rather the second list 110 provide means for selecting another program for example. The second list 110 also includes a banner or identifier 125 which contains the current time, e.g., 11:15, and/or other icons or information, such as the selected channel, e.g., channel E.

The EPG 100 also includes a third menu or an information list 130 which is displayed separately or concurrently with the second list 110 and/or the first list 105 in response to activation of an open switch 135 while the cursor highlights the selected (or default) program 120. Alternatively, the information list 130 may be opened automatically in response to highlighting a program (e.g., by moving the cursor thereon) in the second list 110. The information list 130 includes data associated with the selected or highlighted program 120, such as a description of the program, names of the actors, duration, rating, year produced, and/or a repeat indication of the selected program, as well as other useful information.

The open switch 135 is used to open menus or lists and may have a color such as green, while a close switch 140 is used to close menus and may be yellow for example. The close switch 140 may be provided in second list or menu 110 and/or the first menu 105, as shown by the dashed lines 142. Illustratively, a user may access the EPG 100 by activating the open switch 135 or by other means such as the use of a controller which may be a remote controller as will be described in connection with FIG. 4. The default access or OSD provides the first list/menu 105. The second list/menu 110 may be opened by activating the open switch 135. Alternatively, the second list 110 may be opened automatically in response to moving the cursor along the channels listed on the first list 105. Automatic setting may be activated by double clicking on the open button 135, for example, where an indication of the automatic mode is indicated such as by changing the appearance of the open switch 135 to a darker green or including other indications, such as ‘AUTO’ or the letter ‘A’ therein. Double clicking again would revert the mode from automatic back to manual, where menus are opened in response to activating the open switch 135, instead of in response to highlighting a selected channel or program. All or some of the switches 135, 140, 142, 145, 150, 155 displayed on the screen may be alternatively or additionally included in the remote controller 200 described in connection with FIG. 4.

The EPG 100 also includes a help or information switch 145 configured to open a help menu, which includes information related to the use of the EPG and/or the use of a controller of the EPG, which may be a remote controller as will be described in connection with FIG. 4. The second list 110 may also include other switches such as a reminder switch 150. The reminder switch 150 may be configured to set reminders for the selected program.

The first list 105 includes a further switch referred to as a perspective switch 155, which may be blue for example, activation of which by the user acts on the first list 105 to change the displayed information, e.g., from the channel list shown in FIG. 1 to the theme list 105′ shown in FIG. 2, or the time list 105″ shown in FIG. 3. Depending on the perspective chosen and type of objects or information in the first list 105, the content or information of the second list 110 is automatically changed and associated with the chosen perspective. Thus, by activating the perspective button 155, the user is able to replace the information in the first list 105 by other information which may be programmable by the user. When a perspective is chosen and the desired information is provided on the first list 105, and later the menu or first list 105 is closed, the latest selected perspective or desired information is stored in a memory and will be displayed the next time the user accesses the EPG 100, e.g., the first list 105 is accessed or opened, until another perspective is selected.

The theme menu or themes listed in the first list 105′ shown in FIG. 2 include information categorized by various categories such as news, sports, comedy, comedy-drama, drama, action, comedy-action, detective, suspense, show ratings (sex, violence, etc.), language description, etc., where subcategories or sub themes may be displayed upon highlighting a theme. For example, once ‘sports’ is highlighted, the subcategories that may be displayed include, football, baseball, basketball, hockey, golf, soccer, tennis, etc.

When the perspective is changed to include the themes in the first list 105′, and a theme is selected as indicated by being highlighted or surrounded by a box shown as reference designation 115′ in FIG. 2 for example, then the information in the second list 110′ is changed to a list of channels with their associated programs and time of programs related to the selected theme 115′. The second list 110′ may include the channel list in a chosen or programmable order, such as in a numeric order, and/or times in a chorological or programmable order, which may start around the current time or any other selected or programmed time, e.g., programmed to start a certain time before the current time. The identifier 125′ may display relevant information which may also be programmable, such as ‘available programs for the selected theme’.

Similarly, when the perspective is changed to include a list of times in the first list 105″, as shown in FIG. 3, and a particular time is selected as shown by reference designation 115″, then the information in the second list 110″ is also changed to a list of channels with their associated programs for the selected time 115″. The order of the channel list may be in numerical order or programmable, and the identifier 125″ may display relevant information which may also be programmable, such as ‘available programs for the selected time’. The list of times 105″ may start around the current time or any other selected or programmed time, e.g., programmed to start a certain time before the current time. An information menu 130′, 130″ similar to the information menu 130 described in connection with FIG. 1 may also be displayed to provide data associated with selected or highlighted program 120′, 120″ from the second list 110′, 110″. Additional perspectives may also be programmed, such as a list of favorites, reminders etc.

FIG. 4 shows a remote controller 200 for controlling the OSD of the EPG 100. The remote controller 200 includes an up switch 205 and a down switch 210 which are configured to respectively scroll the cursor or highlighter up and down the lists, including the first 105, second 110, information 130, and/or help lists. The up and down switches 205, 210 may be configured to scroll by pages, instead of or in addition to scrolling singularly by individual entries on the active page. Alternatively, additional page up 215 and page down 220 switches may be provided to respectively move the cursor to the top or bottom of the active list and thereafter scroll by pages. The remote controller 200 further includes a right switch 225 and a left switch 230 configured to move the cursor between the various lists, such as between the first and second lists 105, 110. The remote controller 200 also includes an access switch 240 to access and display the first list 105 of the EPG 100. Double clicking on the access switch 240, or activating an optional program switch 245 displays both the first and second lists 105, 110. A further switch 250 may also be included to activate the perspective function to switch the information included in the first list 105, similar to the perspective button 155 described in connection with FIG. 1.

The EPG may be broadcast and received by a receiver such as a set top box 310 or a television 320 for example, as shown in FIG. 5. A processor 330, 335 may be programmed to operate and control the OSD of the EPG 100. A memory 340, 345 may be coupled to the processor 330, 335 for caching of information that are contiguous to the currently displayed information so that navigation speed of the EPG is increased. For example, when the cursor is on channel E as shown in FIG. 1, then information related the channels that are contiguous or near channel E, such as channels D and F, or channel B, C, D and F, G, H, or the like, are cached in the memory 340, 345. Similarly, for the theme menu 105′, the time menu 105″, and/or information menu 130, information contiguous or near the selected information (e.g., selected program 115, selected theme 115′, selected time 115″, and/or current information menu 130) are cached in the memory.

The controller 200 facilitates navigating of the EPG, such as displaying the first list 105 in response to accessing the EPG, such as by activating the access switch 240; and displaying the second list 110 concurrently with the first list 105 in response to selection (by either moving the cursor or activating the open switch 135, for example) of a selected channel 115 from the channels displayed on the channel list 105, or in response to directly accessing the program list 110 such as by double clicking on the access switch 240 or activating the program switch 245.

In general, the present invention provides fast access to a simple EPG where only relevant information is provided, such as related to a single program at a time, thus providing the needed information in a user friendly manner without additional information that would clutter the display and confuse the user. Further, performance and speed are increased since less information is displayed, while information near or contiguous selected channels or programs are cached awaiting selection by the user of the next channel or program. When the user moves the cursor or highlighter to a different location, such as a different channel, the OSD of the EPG 100 will be quickly updated with the corresponding information. With the remote controller 200, the user can set reminders, highlight themes, as well as open, close and navigate the EPG 100.

The methods of the present invention are particularly suited to be carried out by a computer software program, such computer software program preferably containing modules corresponding to the individual steps of the methods. Such software can of course be embodied in a computer-readable medium, such as an integrated chip, a peripheral device or memory, such as the memory 320, 330 or other memory coupled to the processor 330, 335, which may be a dedicated processor for performing in accordance with the present invention or may be a general-purpose processor wherein only one of many functions operates for performing in accordance with the present invention. The processor may operate utilizing a program portion, multiple program segments, or may be a hardware device utilizing a dedicated or multi-purpose integrated circuit. Each of the above systems utilized for identifying the presence and identity of the user may be utilized in conjunction with further systems.

Finally, the above-discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

1. An electronic program guide (100) comprising:
a first list (105) including first information; and
a second list (110) including second information which is displayed concurrently with said first list (105) in response to selection of a selected information (115) from said first list, said first information being changeable to third information in response to activation of a perspective function.

2. The electronic program guide (100) of claim 1, wherein said second information is exclusively associated with said selected information (115).

3. The electronic program guide (100) of claim 1, wherein said first information and/or said third information include at least one of a channel list, a theme list, a time list, a favorite list and a reminder list.

4. The electronic program guide (100) of claim 1, wherein said first information is programmable to include at least one of a channel list, a theme list, a time list, a favorite list and a reminder list.

5. The electronic program guide (100) of claim 1, wherein when said first information includes a channel list, said selected information (115) is a selected channel, and said second information includes a program list of programs associated with said selected channel and a time list of times associated with said programs.

6. The electronic program guide (100) of claim 1, wherein when said first information includes a theme list, said selected information (115) is a selected theme, and said second information includes a channel list of channels with programs and/or times associated with said selected theme.

7. The electronic program guide (100) of claim 1, wherein when said first information includes a time list, said selected information (115) is a selected time, and said second information includes a channel list of channels with programs associated with said selected time.

8. The electronic program guide (100) of claim 1, wherein said first list (105) is provided in response to accessing said electronic program guide, and both said first list (105) and said second list (110) are provided in response to accessing said second list (110).

9. The electronic program guide (100) of claim 1, wherein said second list (110) includes an identifier (125), said identifier (125) including a current time and/or a description of said second list.

10. The electronic program guide (100) of claim 1, further comprising an information list (130) which is displayed concurrently with said first list (105) and said second list (110), said information list (130) including data associated with a selected program, said data including description, rating and/or repeat indication of said selected program.

11. The electronic program guide (100) of claim 10, wherein said information list (130) is displayed in response to selecting said selected program or in response to activation of an open switch (135) while a cursor highlights said selected program.

12. The electronic program guide (100) of claim 1, wherein said second list (110) includes a reminder switch (150) configured to set reminders, and/or a close switch (140) configured to close said second list.

13. The electronic program guide (100) of claim 1, further including an interface to navigate through said electronic program guide (100), said interface including at least one of:
an open switch (135) configured to open menus including said second list;
a close switch (140) configured to close menus including said first list and said second list;
a perspective switch (155) to activate said perspective function; and
a help switch (145) configured to open a help menu, said help menu including help information related to use of said electronic program guide (100) and/or a controller (200) of said electronic program guide (100).

14. The electronic program guide (100) of claim 13, wherein said controller (200) is a remote controller and includes a perspective button (250) to activate said perspective function.

15. The electronic program guide (100) of claim 13, wherein said controller (200) includes a switch (240) to access said electronic program guide (100), an up switch (205); and a down switch (210); said up switch (205) and said down switch (210) being configured to respectively scroll a cursor up and down said first list (105) and/or said second list (110).

16. The electronic program guide (100) of claim 15, wherein said up switch (205) and said down switch (210) are configured to scroll by pages.

17. The electronic program guide (100) of claim 15, wherein said up switch (205) and said down switch (210) are configured to respectively move said cursor to a top or a bottom of said first list (105) and/or said second list (110) and thereafter scroll by pages.

18. The electronic program guide (100) of claim 15, wherein said up switch (205) and said down switch (210) are respectively configured to singularly move said cursor up and down entries of said first list (105) and/or said second list (110).

19. The electronic program guide (100) of claim 13, wherein said controller (200) includes a right switch (225) and a left switch (230) configured to move said cursor between said first list (105) and said second list (110).

20. A device (310) configured to receive an electronic program guide (100), said electronic program guide (100) comprising:
a first list (105) including first information; and
a second list (110) including second information which is displayed concurrently with said first list (105) in response to selection of a selected information (115) from said first list, said first information being changeable to third information in response to activation of a perspective function.

21. A controller (200) configured to control an on-screen display of an electronic program guide (100), said controller (200) comprising an access switch (240) to access said electronic program guide (100); and navigation switches to navigate through said electronic program guide (100); said electronic program guide (100) comprising:
a first list (105) including first information; and
a second list (110) including second information which is displayed concurrently with said first list (105) in response to selection of a selected information (115) from said first list, said first information being changeable to third information in response to activation of a perspective function.

22. The controller (200) of claim 21, wherein said first list (105) is provided in response to a first activation of said access switch (240), and both said first list (105) and said second list (110) are provided in response to a second activation of said access switch (240) or in response to activation of a program switch (245) of said controller (200).

23. A processor (330) programmed to operate a display monitor; said processor (330) being configured to perform the act of:
receiving an electronic program guide (100);
displaying a first list (105) including first information; and
displaying a second list (110) including second information concurrently with said first list (105) in response to selection of a selected information (115) from said first list, said first information being changeable to third information in response to activation of a perspective function.

24. A method of navigating an electronic program guide (100) comprising the act of:
displaying a first list (105) including first information; and
displaying a second list (110) including second information concurrently with said first list (105) in response to selection of a selected information (115) from said first list, said first information being changeable to third information in response to activation of a perspective function.
